(19) United States
(12) Patent Application Publication
(10) Pub. No.: US 2003/0147546 A1
(43) Pub. Date: Aug. 7, 2003

(54) Purring pillow apparatus

(76) Inventor: Scott Ryan Flack, Bloomington, IL (US)

Correspondence Address: Scott Flack, 1 Yew CT., Bloomington, IL, 61701, US

(21) Appl. No.: 10/061,485

(22) Filed: Feb. 4, 2002

(51) Int. Cl. H04R 1/02; H04R 9/06

(52) U.S. Cl. 381/333; 381/388

(57) ABSTRACT

The apparatus is of a modified recording module loaded with a pre-recorded purring cat sound. The recording module is housed within an enclosure for durability and child safety. The module playback (purring sound) is triggered by a push-button connected to the modified recording module and is located on the outside top of the sealed enclosure. A 2-position slide switch is incorporated into the battery leads of the recording module to give it an On/Off function. The pillow face has a smooth material and the bottom of the pillow is of a furry synthetic material simulating a cat. The enclosure is placed between the padding of the pillow and the pillow is sealed with a zipper. The purring sound is activated when the slightest pressure is applied to either the top or bottom of the pillow.

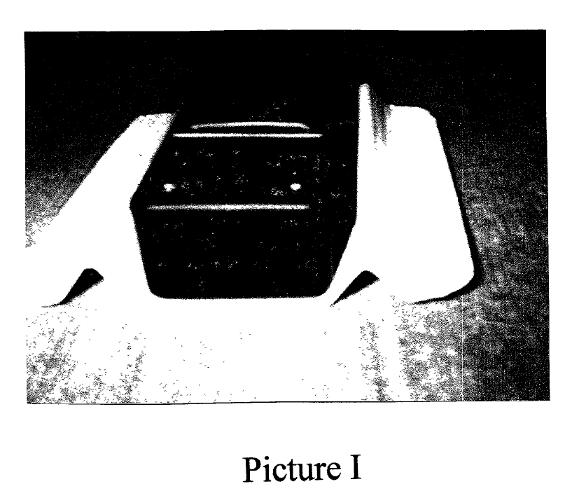

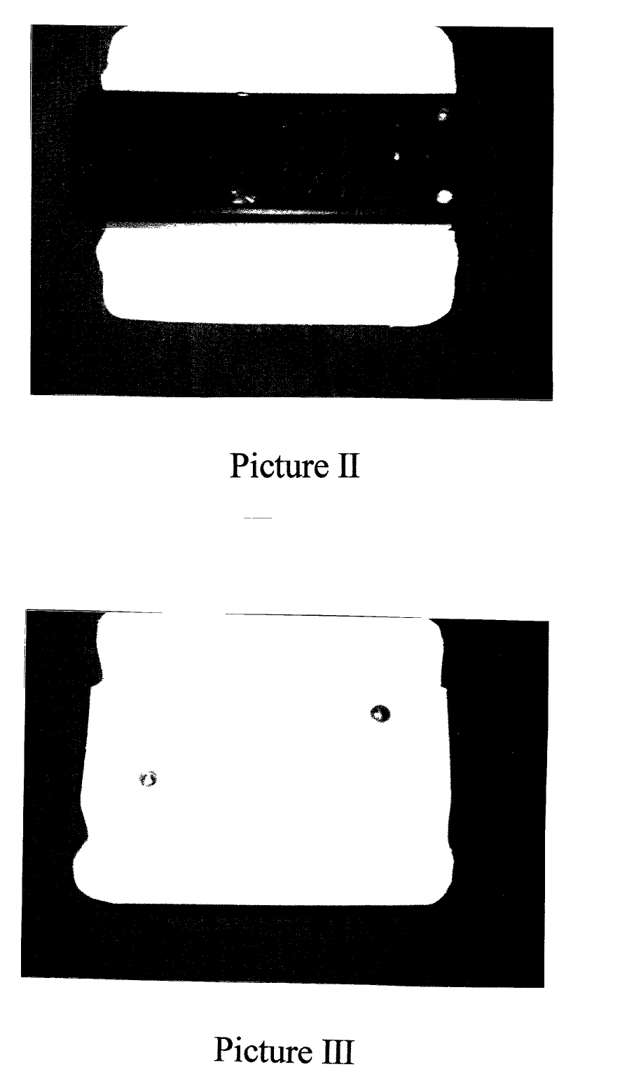

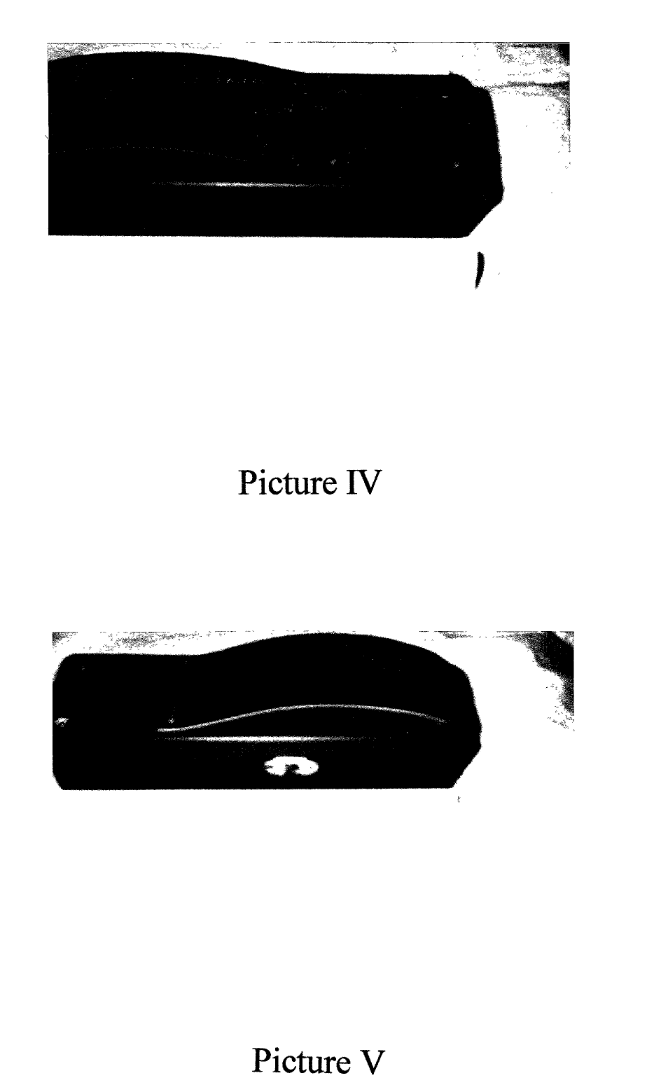

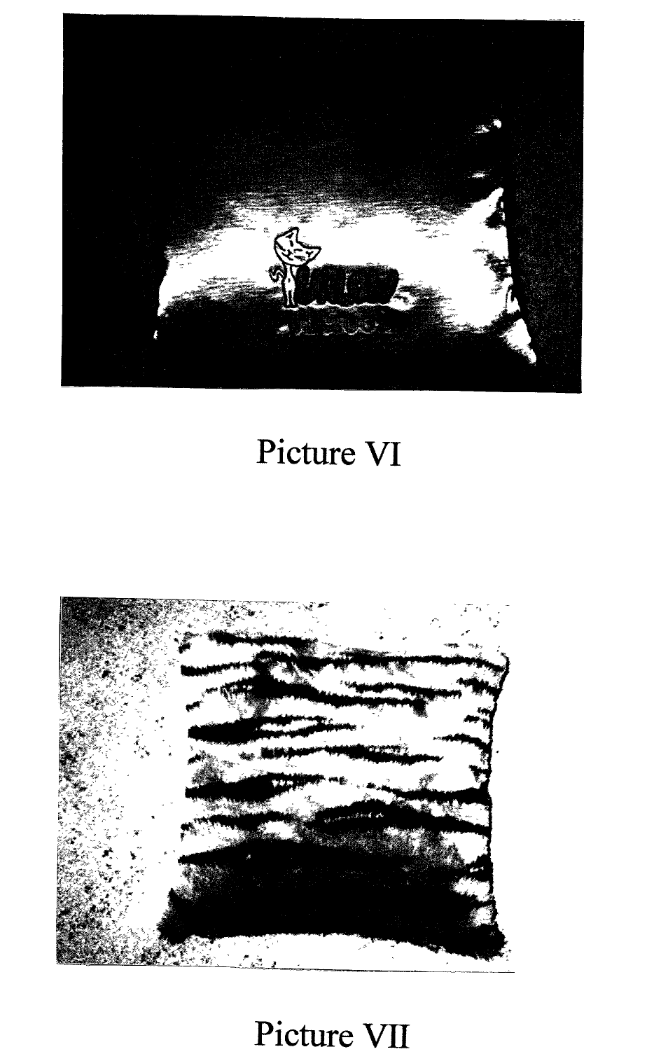

The purring pillow is an apparatus that makes a purring sound when the slightest pressure is applied to the pillow.

The purring pillow apparatus is designed by placing a modified 20-second recording module into a 6″×2″×1″ enclosure. The recording module play button is removed from the circuit board and 2 wires are soldered in place. The other end of the wires are soldered to a push-button and mounted to the lid of the enclosure. A 2-position slide switch is incorporated into the battery leads of the recording module to give it an On/Off function.

Holes are drilled into the enclosure lid to simulate a speaker grill so that the speaker of the recording module can be fastened to the inside of the enclosure with hot glue. A pre-recorded purring cat sound is recorded into the recording module. When the push-button is triggered, the purring sound is activated.

A plastic flap is fitted to the exterior of the lid, arching over the push-button and fastened at one end just in front of the speaker holes. This is to distribute the activation pressure placed on the apparatus so that direct central contact to the switch to trigger the sound isn't necessary.

The contents of the recording module (speaker, record button, wiring), a 9V battery, and the push-button are all fitted into the enclosure and the enclosure is sealed. The 2-position slide switch is glued to the exterior of the enclosure with the wires facing in.

A wider base is then mounted to the bottom of the enclosure to prevent the enclosure from flipping around once inside the pillow. The entire apparatus is then inserted into the pillow between the padding and the pillow is sealed with a zipper.

The pillow face has a smooth material and the pillow bottom is of a synthetic fur-like material simulating the feel of a cat. When the slightest pressure is applied to the top or bottom side of the pillow, the purring sound is activated.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

To my knowledge, there is no background to this invention. It is a concept thought up by myself as a soothing sound to calm children by lying on a purring pillow. The invention parallels many children's toys, as there are many toys that are soothing and play sounds but none of this design.

### BRIEF SUMMARY OF THE INVENTION

The purring pillow apparatus is designed to create a soothing purring sound of a cat when any slight pressure is applied to the pillow. The apparatus containing a pre-recorded cat sound is placed inside a pillow between the padding. The pillow face has a smooth material and the bottom of the pillow is of a fury synthetic material simulating a cat.

### BRIEF DESCRIPTION OF THE SEVERAL VIEWS OF THE PICTURE

See enclosed PICTURES DISCLOSURE.

### DETAILED DESCRIPTION OF THE INVENTION

The following parts are necessary in building the Purring Pillow Apparatus:

Primary Parts

(1) 6″×2″×1″ Plastic Enclosure (1) 20-Second Recording Module

(1) Push-button Switch (1) 2-Position Slide Switch

(1) 9V Battery Holder (1) 3″ of 24ga. Speaker Wire

Miscellaneous Parts

(1) Piece of skirting for base (2) Bolts

(2) Washers (2) Lock Washers

(2) Nuts (1) Piece of stiff wire

Solder Hot Glue

Plastic flap Pillow

### Pictures Disclosure

To the Commissioner of Patents and Trademarks:

Your petitioner, Scott Flack, a citizen of the United States and a resident of Bloomington, Ill., prays that letters patent may be granted for a Utility patent of a purring pillow apparatus, as set forth in the following specification.

Picture I is a front view. The white wider base is mounted to the device to prevent the enclosure from flipping around once inside the pillow.

Picture II is a top view. The speaker holes for the speaker can be seen in this view on the middle right of the apparatus.

Picture III is a bottom view. The base can be seen fully in this view. Two bolt heads and washers can be seen from this view. The bolts attach to the inside bottom of the apparatus to hold the base and apparatus together.

Picture IV is a left-side view. This view shows how the plastic flap curves over the button, which is mounted on top of the apparatus.

Picture V is a right-side view. This view is much like the left-side view except that this side shows the On/Off switch for the apparatus, which is mounted on the side just right of center.

Picture VI is a top view of the pillow. This is only included in the patent documentation as a visual representation of what the pillow will look like. In no means is this used as a Design patent as I have no intentions of applying for a design patent for the design of the pillow itself, just the purring apparatus of the pillow.

Picture VII is a bottom view of the pillow. This side of the pillow is made of a furry synthetic material simulating the feel of a cat.

Step 1—Cut the 9V battery holder to fit between the plastic ribs of the 6″×2″×1″ enclosure. Glue battery holder to side of enclosure.

Step 2—Modify the play switch on the recording module by removing the play switch and soldering 2 pieces of wire (one on each side) to the circuit board. Solder the other ends of the wire to the push-button switch.

Step 3—Drill a hole in the center of enclosure lid to mount push-button switch. Drill numerous holes at one end of enclosure lid in a circular pattern to emulate a speaker grill. Drill 2 holes in the bottom of enclosure at opposite corners to mount base to enclosure.

Step 4—Cut one 9V lead wire on recording module at midway point. Solder one end of wire to center mount of 2-position slide switch and other end to either slide switch end mount. Cut/drill a hole on the side of the enclosure to mount the slide switch. Glue to hold in place.

Step 5—Cut out a piece of skirting 6″ long and 4″ wide. Fasten skirting to base of enclosure with two bolts, washers, lock washers, and nuts. This acts as a wider base for the unit so that it does not turn or flip when enclosed in the pillow.

Step 6—Lay the speaker unit face down on the inside of the lid over the drilled speaker holes. Hot glue the speaker in place in 4 spots.

Step 7—Cut out a flap of plastic 1-⅝″×4″ from a butter crock. Round off the corners of one end. Align the flap so that it covers the lid face and push-button hole and the non-rounded end is at the edge of the speaker holes but do not cover them. Drill 2 small holes (one at each corner of the non-rounded end) through the plastic flap and the lid. Fasten the flap to the lid with a stiff piece of wire—looping it through both holes and twisting ends together on inside of lid. Mount the push-button to the lid. The flap should arch over the push-button.

Step 8—Insert a 9V battery into the battery holder and connect to the recording module. Record the pre-recorded sample of a purring cat from the computer into the recording module. Test the push-button and the slide switch so that each work as necessary.

Step 9—Mount the enclosure lid onto the enclosure base keeping the recording module and all wires inside the enclosure. Slide the purring pillow apparatus into the open end of the pillow between the padding and seal the pillow with a zipper.

What I claim as my invention is the purring pillow apparatus. It is designed to create a soothing purring sound of a cat when any slight pressure is applied to the pillow. The apparatus containing a pre-recorded cat sound is placed inside a pillow between the padding. The pillow face has a smooth material and the bottom of the pillow is of a furry synthetic material simulating a cat.

I claim:

1. A purring pillow apparatus that makes a purring sound when the slightest pressure is applied to the pillow.

2. The purring pillow apparatus according to claim 1, wherein the apparatus is designed by placing a modified 20-second recording module into a 6″×2″×1″ enclosure. The recording module play button is removed from the circuit board and 2 wires are soldered in place. The other end of the wires are soldered to a push-button and mounted to the lid of the enclosure A 2-position slide switch is incorporated into the battery leads of the recording module to give it an On/Off function.

3. The purring pillow apparatus according to claim 2, wherein holes are drilled into the enclosure lid to simulate a speaker grill so that the speaker of the recording module can be fastened to the inside of the enclosure with hot glue. A pre-recorded purring cat sound is recorded into the recording module When the push-button is triggered, the purring sound is activated.

4. The purring pillow apparatus according to claim 3, wherein a plastic flap is fitted to the exterior of the lid, arching over the push-button and fastened at one end just in front of the speaker holes. This is to distribute the activation pressure placed on the apparatus so that direct central contact to the switch to trigger the sound isn't necessary.

5. The purring pillow apparatus according to claim 2, wherein the contents of the recording module (speaker, record button, wiring), a 9V battery, and the push-button are all fitted into the enclosure and the enclosure is sealed. The 2-position slide switch is glued to the exterior of the enclosure with the wires facing in.

6. The purring pillow apparatus according to claim 2, wherein a wider base is then mounted to the bottom of the enclosure to prevent the enclosure from flipping around once inside the pillow. The entire apparatus is then inserted into the pillow between the padding and the pillow is sealed with a zipper.

7. The purring pillow apparatus according to claim 1, wherein the pillow face has a smooth material and the pillow bottom is of a synthetic fur-like material simulating the feel of a cat. When the slightest pressure is applied to the top or bottom side of the pillow, the purring sound is activated.
